(19) United States
(12) Patent Application Publication
(10) Pub. No.: US 2005/0001089 A1
(43) Pub. Date: Jan. 6, 2005

(54) Pneumatic gliding wing for a freefall jumper

(76) Inventors: Yves Rossy, Celigny (CH); Frederik E. To, Northampton (GB)

Correspondence Address: JENKENS & GILCHRIST, PC, 1445 ROSS AVENUE, SUITE 3200, DALLAS, TX, 75202, US

(21) Appl. No.: 10/496,171

(22) PCT Filed: Feb. 12, 2002
(86) PCT No.: PCT/CH02/00082

(30) Foreign Application Priority Data
Nov. 26, 2001 (CH) 217/001

(51) Int. Cl. B64D 10/00

(52) U.S. Cl. 244/4 A

(57) ABSTRACT

The invention relates to a pneumatic gliding wing (1) for a freefall jumper (2), comprising a rigid part (3) which is made of, for example, a composite material such as GFK or CFK. Said rigid part is provided with a recess (5) for a parachute (6) for the jumper (2) and contains a device for supplying and administering compressed gas. Said rigid part has a pocket (7) with a closure (8) and eyelets (9) for the parachute of the pneumatic gliding wing (1) which is arranged on the side orientated towards the jumper (2). A cord (10) is drawn through the eyelets (9) and can, for example, be secured to a leg of the jumper (2). Outer parts (4) which can be impinged upon with pressurised gas are secured to the outer rigid part (3) of the pneumatic gliding wing (1) and are activated only when the jumper has left the aeroplane. When the gliding phase has finished, the jumper opens the parachute (6) and so long as this is done, the jumper opens a discharge valve on the outer parts (4) which fold back, whereupon the jumper can land in the normal way with the parachute (6).

The present invention is concerned with a pneumatic gliding wing for freefall jumpers according to the precharacterizing clause of patent claim 1.

A particular type of parachuting sport is known in which the parachutists first of all allow themselves to fall in freefall for several hundred to several thousand meters and the parachutes open only for the last phase of the jump. In this freefall phase, the jumper can be steered to a limited extent; however, actual flying cannot occur for aerodynamic reasons.

This has led to some freefall jumpers of this type buckling on short wings which, to a limited extent, permit flying, flying which can be controlled by the body directly, without the assistance of control elements. Due to the size of the exit doors of the aircraft used by the freefall jumpers, narrow limits are placed on the wings which can be used, and so a lift/drag ratio in the range of 2 to 3 approximately represents the prior art.

Even if the exit hatch of the aircraft used permits the use of a wing having a large span, the fact remains, as a substantial drawback, that the wing has to jettisoned in the landing phase: if the jumper opens the parachute, then the wing, on which the flow impinges transversely in the position of the jumper which is now necessary, produces such an air resistance that the parachute cannot be brought into the correct position. For this reason, the known gliding wings are not only constructed virtually without exception in a manner such that they can be jettisoned—which is necessary for safety reasons—but also actually have to be jettisoned. These wings are therefore always equipped with their own parachute. After landing with the parachute, the freefall jumper therefore also has to rescue his wing.

A gliding wing which is not provided pneumatically is disclosed, for example, in DE 197 49 936 (D). This wing overcomes the abovementioned drawback of the limited size of the exit doors by the fact that it has wing parts which can be unfolded and folded. These are intended to be unfolded either after the jump from the aircraft by the muscle power of the jumper or by the action of actuators which are tensioned before the jump, in any case, therefore, purely mechanically. For the landing of the jumper provision is made—as mentioned—to separate the wing from the jumper, so that the landing using the parachute can take place in an aerodynamically undisturbed manner.

U.S. Pat. No. 3,372,893 (D2) has disclosed a pneumatic gliding wing which is closer to the present invention. D2 proposes integrating a gliding wing in the ejection seat of a fighter pilot who, after making an emergency exit and suspended from the parachute, can activate the gliding wing using compressed gas. The intention is then for it to be possible for the parachute to be jettisoned.

The wing proposed here in D2 does not fulfill essential requirements which are made of a wing. In addition, such considerable quantities of gas are required in order to inflate an entire gliding aircraft as claimed here that they are not suitable as a working load for a fighter pilot in an emergency exit.

A pneumatic wing per se is furthermore disclosed in EP 0 851 829 (D3) by the same applicant as for the above patent application.

The object of the present invention is to provide a pneumatic gliding wing for freefall jumpers which improves the lift/drag ratio, is reliable in operation and can be worn right up to landing.

The achievement of the object which is set is reproduced in the characterizing part of patent claim 1 in respect of its essential features, and in the following claims in respect of further advantageous developments.

The invention is explained in greater detail with reference to the attached drawing, in which

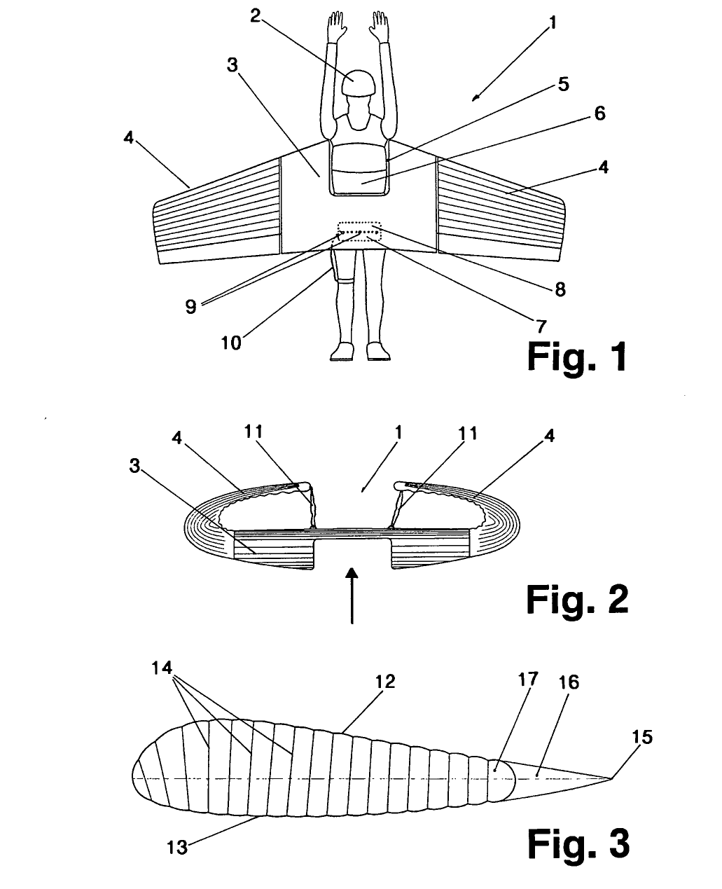

FIG. 1 shows a first exemplary embodiment of a pneumatic gliding wing according to the invention in a plan view,

FIG. 2 shows the first exemplary embodiment in the inoperative state in the view from the front,

FIG. 3 shows a cross section through the pneumatic part of the pneumatic gliding wing,

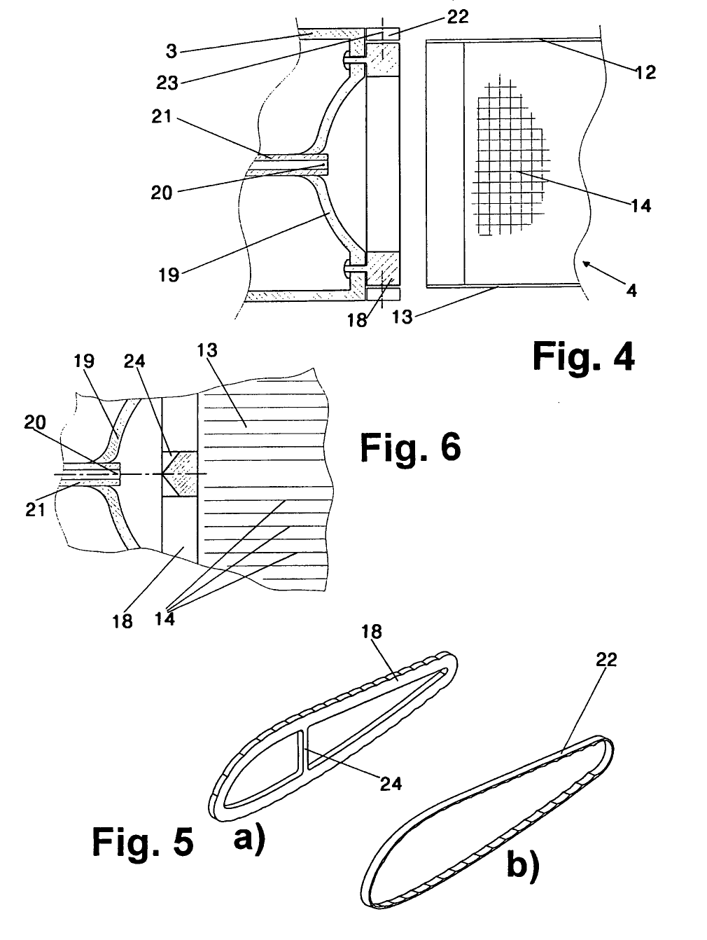

FIG. 4 shows an exert of the longitudinal section of the pneumatic gliding wing,

FIG. 5 shows a detail of the connection of the pneumatic part of the pneumatic gliding wing in one perspective,

FIG. 6 shows the illustration of FIG. 4 in a longitudinal section running perpendicularly thereto,

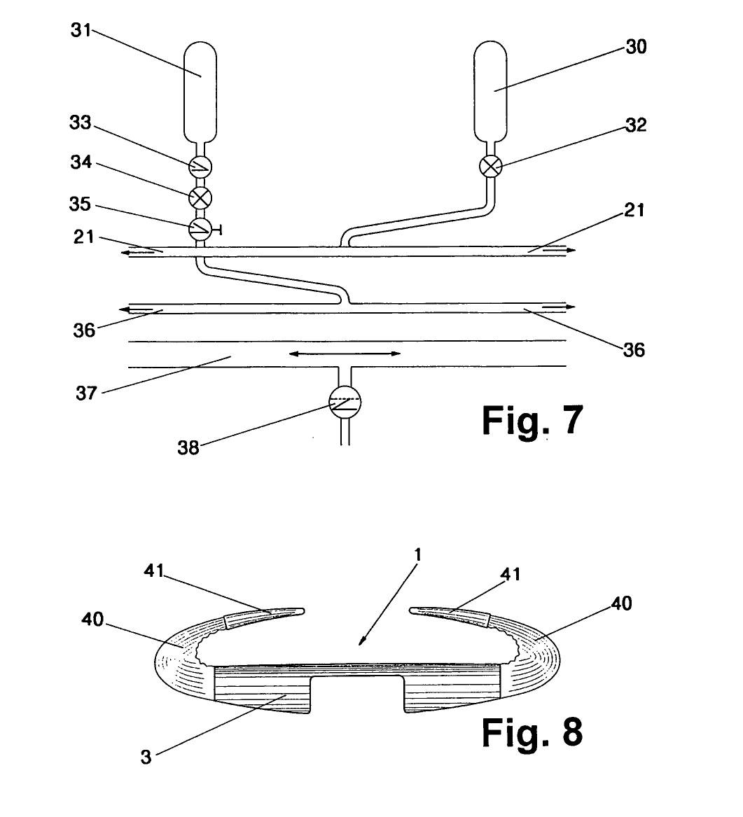

FIG. 7 shows a device for supplying and managing the compressed gas,

FIG. 8 shows a second exemplary embodiment in the illustration of FIG. 2.

FIG. 1 is the illustration of a first exemplary embodiment of a pneumatic gliding wing 1 in the plan view from above, together with a jumper 2. The pneumatic gliding wing 1 is divided into a central, fixed part 3 and two outer parts 4 which are attached thereto and are designed as pneumatic wings, for example in accordance with EP 0 851 829. These wings have a slack state and an operative state in which they are charged with compressed gas. FIG. 1 illustrates the operative state.

The jumper 2 wears the fixed part 3 of the pneumatic gliding wing buckled onto the rear side of his body by straps (not visible here). The fixed part 3 has a relatively large cutout 5 which leaves space for a folded parachute 6 which is stowed in the corresponding bag. A further bag 7 is fitted, for example, in the lower part of the fixed part 3 and contains the parachute for the pneumatic gliding wing 1 (illustrated by dashed lines in FIG. 1, since it is situated on that side of the wing 1 which faces the jumper 2). This bag 3 has a fastening 8 with, for example, three eyelets 9 through which a plastic chord 10 is pulled, the other end of which is fastened, for example, to a leg of the jumper 2. If he has to be separated from his pneumatic gliding wing 1, which is only envisaged for emergency situations, then the spatial separation of pneumatic gliding wing 1 and jumper 2 causes the chord 10 to be pulled out of the eyelets 9, the fastening 8 of the bag 7 to open and discharge the parachute folded up in it.

Of course, the bag 7 may also be integrated in the aerodynamically favorably configured fixed part 3 of the pneumatic gliding wing 1 in such a manner that the fastening 8 of the bag 7 has the same structure and surface quality as the fixed part 3. The design of the fastening 8 is not affected by this.

FIG. 2 illustrates the pneumatic gliding wing 1 from FIG. 1 in an uninflated state in the view from the front; the illustration of the jumper 2 has been omitted here. The outer parts 4 are, as illustrated, bent back by the flow, which is illustrated in FIG. 2 by an arrow. Before the jump out of the carrier aircraft and before the inflation of the outer parts 4, the latter can be held back on the fixed parts 3 of the pneumatic gliding wing 1 by a tape 11. The tape 11 acts on the tip of the outer part 4 (as on the left in FIG. 2) or in the vicinity thereof (as on the right in FIG. 2), and is set back in such a manner that small forces in the range of 1-5 N cause it either to tear or become completely detached from the pneumatic gliding wing 1.

Whereas the fixed part 3 of the pneumatic gliding wing 1 is designed in a manner known per se from composite materials, such as glass fiber-reinforced plastic or carbon fiber-reinforced plastic, the outer parts 4, as already mentioned, are designed as pneumatic wings. FIG. 3 shows a cross section through one of the outer parts 4. Textile webs 14, as are disclosed, for example, in EP 0 851 829, are tensioned between an upper skin 12 and a lower skin 13 of a hermetically sealed envelope. The trailing edge (designated by the number 15) is tensioned by a multiplicity of approximately triangular supporting profiles 16 which are essentially cut to the contour of a last pneumatic segment 17 and are supported thereon. The fixing of the supporting profiles on the segment 17 and on the lower and upper skins 13, 12 is undertaken, for example, by means of adhesive fastenings.

The transition from the fixed part 3 to the pneumatic outer parts 4 is illustrated in FIG. 4, a longitudinal section through the pneumatic gliding wing 1 transversely to the flying direction. A suitably shaped metallic frame 18—illustrated on its own in FIGS. 5a, b—is fastened to the fixed part 3. The frame bears, for example, a shell-shaped structure 19 in which an inflow opening 20 of a compressed-gas line 21 is arranged. The outer border of the frame 18 corresponds in shape and size precisely to the inner border of the outer part 4, which is manufactured from textile material. The webs 14 leave the upper and lower skins 12, 13 of the outer part free to an extent sufficient to enable them to be pulled over the frame 18 and bonded and to fit snugly there. A second frame 22 which corresponds in shape and size to the outer border of the outer part 4 at this point is slipped onto this frame. In order to secure the outer frame 22, screws 23, for example, can be provided.

FIGS. 5a, b are perspective illustrations of the frames 18, 22 for connecting the fixed part 3 and one of the outer parts 4. Of course, there is a symmetrically designed pair of frames 18, 22 on the other side of the fixed part 3. As FIGS. 5a, b show, the outer contour of the inner frame 18 takes on, in the state in which it is charged with compressed gas, the shape of the outer part 4 defined by the upper and lower skins 12, 13 and the textile webs 14. The same applies to the outer frame 22.

The inner frame 18 furthermore has a connecting web 24 whose function not only resides in the stabilization of the frame 18, but which serves, for example, as a diffuser for the compressed gas, as FIG. 6 shows.

FIG. 6 is a longitudinal section in the plane of the wing through an exert of the pneumatic gliding wing 1 in the region where the fixed part 3 and the outer part 4 are joined together. The longitudinal section runs through the inflow opening 20 of the compressed-gas line 21. The textile webs 14 and the connecting web 24 are likewise cut away. The compressed gas flowing in through the inflow opening 20 impacts directly against the connecting web 24 which has two roof-shaped bevels 26 in the region of the axis (designated by 25) of the compressed-gas line 21 and thus distributes the flow of compressed gas. The compressed gas is therefore distributed rapidly to the individual segments of the pneumatic outer part 4 which lie between the webs 14. FIG. 7 is the illustration of a solution according to the invention of the supply and management of compressed gas. There are two compressed-gas stores 30, 31 which are arranged, for example, in the region of the wing center sections of the fixed part 3. The two stores have a volume of the order of magnitude of 0.2 to 2 liters. The initial pressure in the compressed-gas store 30 is dimensioned in such a manner that its filling in accordance with the Boyle-Marriott law
p₁V₁=p₂V_{2 isothermal}
where
p₁=pressure in the compressed-gas store 30
p₂=pressure in the outer parts 4, 40
V₁=volume of the compressed-gas store 30
V₂=volume of the outer parts 4, 40
   is sufficient in order to pump the two outer parts 4 up to a working pressure of the magnitude of approximately 400-600 hPa. The compressed-gas store 30 is closed and opened by an open-closed valve 32 which feeds the two compressed-gas lines 21 in a symmetrical arrangement.

The second compressed-gas store 31 with a volume V₃₁ of the same order of magnitude of volume as V₁ has, for example, the maximum initial pressure, thus, for example, 200 bar. This pressure is used to act upon a pressure-reducing valve 33 which reduces the pressure to, for example, 5-10 bar. A second open-closed valve 34 operates at this pressure, the initial pressure of the valve being brought by an adjustable control valve 35 to a working pressure of 400-600 hPa. This gas flow is distributed in turn in a symmetrical arrangement through two compressed-gas lines 36 to the two outer parts 4.

As an alternative to this, the compressed-gas lines 36 can lead into the compressed-gas lines 21, or the gas flow of the control valve 35 can be guided directly into the compressed-gas line 21.

Furthermore, there is a connecting line 37 of large cross section which connects the two outer parts 4 and ensures that their pressure is continuously equalized. A pressure control valve 38 is fitted on the connecting line 37 and—in a preadjustable manner—maintains the designated positive working pressure p₂, for example of 500 hPa, and releases air flowing in through the control valve 35 if a positive pressure occurs.

If the jumper opens the wing at, for example, 5000 m above sea level, then the atmospheric pressure is approximately 550 hPa. If the jumper then drops to approximately 500 m above sea level, the atmospheric pressure increases to approximately 950 hPa, which, in order to maintain the mechanical properties of the pneumatic outer parts 4, 40, necessitates a continual redelivery of compressed gas from the compressed-gas store 31. The presence of the pressure control valve 38 makes it possible to always keep the internal pressure of the outer parts at a safe level. The actuation of the open-closed valves 32, 34 takes place during flight. Their actuating members are therefore guided onto the outside of the fixed part 3 and are arranged locally in such a manner that the jumper can open them with one maneuver in each case. A closing process during the flight is neither necessary nor envisaged.

When the jumper during the flight reaches the height at which he would like to open his parachute 6, then he first of all actuates the triggering mechanism thereof. As soon as the parachute 6 is supporting him, he opens a relief valve, which is combined with the pressure control valve 38, whereupon the air in the outer parts 4, 40 expands, and the latter fold to the rear. The air resistance of the pneumatic gliding wing 1, against which the flow now impinges transversely, is therefore reduced to such an extent that the jumper is able to undertake gliding using the parachute 6 with scarcely any impediment. A jettisoning of the pneumatic gliding wing 1 is therefore not required during normal operation of the pneumatic gliding wing 1. The possibly difficult searching for and retrieval of the pneumatic gliding wing 1 after the end of the parachuting phase is therefore also superfluous.

FIG. 8 illustrates a second exemplary embodiment of the pneumatic gliding wing 1 according to the invention. Like that of the first exemplary embodiment according to FIGS. 1 and 2, it has a fixed part 3 which is taken on without any changes. This fixed part 3 is adjoined by two short outer parts 40 which correspond in respect of construction and fastening to the outer parts 4 of the first exemplary embodiment. Wing tips 41 which are constructed in turn as fixed parts, similar to the fixed part 3, are fastened to these short outer parts 40. The connection to the outer parts 40 takes place in the manner shown in FIGS. 4, 5.

Since it is neither necessary nor desired to charge the wing tips 41 with compressed gas, these are hermetically sealed off from the outer parts 40 in the region of the inner frame 18. In the slack state, the outer parts 40 take on here a hinge function between the fixed part 3 and the fixed wing tips 41. The initial pressure in the compressed-gas store 30 can therefore be set to be lower; in addition, the period of time between opening of the open-closed valve 32 and complete operational readiness of the pneumatic gliding wing 1 is shortened.

1. A pneumatic gliding wing (1) for freefall jumpers (2), having a harness for fastening the pneumatic gliding wing (1) on the back of the jumper (2), having a separate parachute, which is folded in a bag (7), for the pneumatic gliding wing (1), and a cutout (5) for a parachute (6) which the jumper (2) wears on his back, characterized in that
the pneumatic gliding wing (1) is constructed from a fixed part (3), which comprises and connects the wing center sections and to which the harness is fastened,
there are furthermore two outer parts (4, 40) which are attached in a hermetically sealed manner to the fixed part (3),
which outer parts (4, 40) consist of textile material, can be charged with compressed gas and, in the operative state, are charged with compressed gas,
which outer parts can furthermore be relieved of the compressed gas for the inoperative state and can then fold away in the state in which the flow impinges transversely, so that the jumper can carry out the flight phase executed using the parachute (6) without jettisoning the pneumatic gliding wing (1),
there is a device for the supply and management of the compressed gas.

2. The pneumatic gliding wing (1) as claimed in patent claim 1, characterized in that
the outer parts (4) consist of a textile upper skin (12) and a textile lower skin (13) which are both connected by a multiplicity of textile webs (14) which are situated essentially perpendicularly on the upper and lower skins (12, 13) and with respect to the flow direction of the air around the pneumatic gliding wing (1), the upper and lower skins (12, 13) hermetically sealing the interior of each outer part (4) to the outside, but, the textile webs (14) being air-permeable and dividing the interior of the outer parts (4) into a multiplicity of segments,
a segment (17) which is rearmost in the flow direction being likewise sealed hermetically to the outside,
the pneumatic gliding wing (1) having a leading edge (15) which is constructed and supported by a further multiplicity of supporting profiles (16), the supporting profiles (16) for their part being supported on the rearmost segment (17) of the outer parts (4), and the upper and lower skins (12, 13) extending over the supporting profiles, being joined together behind them and being tensioned by them,
the textile materials for the upper and lower skins (12, 13) and for the folded webs (14) have little extensibility,
the outer parts extend as far as the tips of the pneumatic gliding wing (1).

3. The pneumatic gliding wing (1) as claimed in patent claim 2, characterized in that
the fixed part (3) is hermetically sealed at its ends from the outer parts (4, 40) by a respective shell-shaped structure (19) which curves inward toward the fixed part (3) and which bears, essentially in the center, an inflow opening (20) of a compressed-gas line (21) which is directed toward the outer parts (4, 40),
the fixed part (3), at its outer ends toward the outer parts (4, 40), bears a respective first frame (18) which is connected fixedly to the fixed part (3) and the outer border of which corresponds in shape and size precisely to the inner border of the outer parts (4, 40) which are manufactured from textile material, the textile webs (14) leaving the upper and lower skins (12, 13) free sufficiently for them to be able to be pulled over the frame (18) and to fit snuggly there,
the upper and lower skins (12, 13) are bonded in a hermetically sealed manner to the frame (18) formed in this manner,
there is a second frame (22) which corresponds in shape and size to the outer border of the outer part (4, 40), and the second frame (22) can be pushed over the outer part (4, 40), which is bonded to the frame (18), and can be secured there.

4. The pneumatic gliding wing (1) as claimed in patent claim 3, characterized in that the first frame (18) has a connecting web (24) which runs essentially perpendicularly to the plane of the wing and is fitted locally in such a manner that it lies on the longitudinal axis of the inflow opening (20) of the compressed-gas line (21) and is beveled in a roof-shaped manner on the side facing the latter.

5. The pneumatic gliding wing (1) as claimed in patent claim 1, characterized in that
the outer parts (40) consist of a textile upper skin (12) and a textile lower skin (13) which are both connected by a multiplicity of textile webs (14) which are situated essentially perpendicularly on the upper and lower skins (12, 13) and with respect to the flow direction of the air around the pneumatic gliding wing (1), the upper and lower skins (12, 13) hermetically sealing the interior of each outer part (4) to the outside, but, the textile webs (14) being air-permeable and dividing the interior of the outer parts (4) into a multiplicity of segments,
a segment (17) which is rearmost in the flow direction being likewise sealed hermetically to the outside,
the pneumatic gliding wing (1) having a leading edge (15) which is constructed and supported by a further multiplicity of supporting profiles (16), the supporting profiles (16) for their part being supported on the rearmost segment (17) of the outer parts (40), and the upper and lower skins (12, 13) extending over the supporting profiles, being joined together behind them and being tensioned by them,
the textile materials for the upper and lower skins (12, 13) and for the folded webs (14) have little extensibility,
wing tips (41) adjoin the outer parts (40) on the outside and are produced in a fixed construction and are hermetically sealed from the outer parts (40),
the wing tips (41) are connected to the outer parts (40) in the same manner as the fixed part (3) is connected to the outer parts (40).

6. The pneumatic gliding wing (1) as claimed in patent claim 1, characterized in that there is a device for the supply and management of compressed gas and it is accommodated in the fixed part (3) of the pneumatic gliding wing (1).

7. The pneumatic gliding wing (1) as claimed in patent claim 6, characterized in that
the device for the supply and management of compressed gas has two compressed-gas stores (30, 31), the first compressed-gas store (30) with a volume V₁ being filled to the pressure p₁ sufficiently for the compressed gas stored in it to reach when it expands into the volume V₂ of the outer parts (4, 40) in order to produce the pressure p₂ there, in which case
p₁V₁=p₂V_{2 isothermal}
the second compressed-gas store (31) with a volume V₃₁ is filled to a pressure p₃₁ to an extent so that its content suffices in order to continuously maintain the positive pressure p₂ in the outer parts (4, 40) during the dropping of the pneumatic gliding wing (1).

8. The pneumatic gliding wing (1) as claimed in patent claim 7, characterized in that the positive pressure P2 lies in the range from 400-600 hPa.

9. The pneumatic gliding wing (1) as claimed in patent claim 7, characterized in that
the first compressed-gas store (30) has a first open-closed valve (32) which feeds the two compressed-gas lines (21) in a symmetrical arrangement,
the second compressed-gas store (32) acts upon a pressure-reducing valve (33) which reduces the filling pressure of the compressed-gas store (32) to a pressure of 5-10 bar,
there is a second open-closed valve (34) which is arranged behind the pressure-reducing valve (33),
there is a control valve (35) and it is arranged downstream of the second open-closed valve (34) and can be set in such a manner that it can maintain the positive pressure P2 provided in the outer parts (4),
the control valve (35) outputs the compressed gas output by it in a symmetrical arrangement through two second compressed-gas lines (36) to the two outer parts (4).

10. The pneumatic gliding wing (1) as claimed in patent claim 9, characterized in that the second compressed-gas lines (36) lead into the first compressed-gas lines (21).

11. The pneumatic gliding wing (1) as claimed in patent claim 9, characterized in that there is a connecting line (37) which connects the two outer parts (4, 40) and ensures a continuous equalization of pressure between these outer parts (4, 40).

12. The pneumatic gliding wing (1) as claimed in patent claim 11, characterized in that a pressure control valve (38) is arranged on the connecting line (37) and can be set in such a manner that it lets out compressed gas if the positive pressure p₂ of the two outer parts (4, 40) exceeds the designated value.

13. The pneumatic gliding wing (1) as claimed in patent claim 12, characterized in that a relief valve is combined with the pressure control valve (38), the relief valve making it possible to relieve the outer parts (4, 40), so that their internal pressure corresponds permanently to the local atmospheric pressure.

14. The pneumatic gliding wing (1) as claimed in patent claim 13, characterized in that there are actuating elements for the open-closed valves (32, 34) and the relief valve and they are arranged on the outside of the pneumatic gliding wing (1) in such a manner that they can be operated during the flight.
